(19) United States
(12) Patent Application Publication
(10) Pub. No.: US 2024/0306834 A1
(43) Pub. Date: Sep. 19, 2024

(54) DOUBLE DRAPE EXTENSION DEVICE

(71) Applicant: Canwil Textiles, Inc., Auburn, GA (US)

(72) Inventor: Nikhil Narwani, Decatur, GA (US)

(21) Appl. No.: 18/677,653

(22) Filed: May 29, 2024

Related U.S. Application Data
(63) Continuation of application No. 17/857,396, filed on Jul. 5, 2022, now abandoned.
(60) Provisional application No. 63/218,012, filed on Jul. 2, 2021.

(51) Int. Cl. A47H 1/02; F16M 11/24

(52) U.S. Cl. CPC A47H 1/02; F16M 11/24

(57) ABSTRACT

Provided herein are novel a double-sided extension devices for upright drapery systems, such as those used in decorating temporary event spaces. The extension device can extend the height of a drapery system while advantageously allowing for use of slots of the original upright to receive a drape support.

### CROSS-REFERENCE TO RELATED APPLICATIONS

This application is a continuation of U.S. patent application Ser. No. 17/857,396, filed on Jul. 5, 2022, which claims priority under 35 U.S.C. § 119(e) to U.S. Provisional Application No. 63/218,012, filed on Jul. 2, 2021, the entire contents of which are incorporated herein by reference.

### TECHNICAL FIELD

This disclosure relates to a double-sided extension device for upright drapery systems, such as those used in decorating temporary event spaces. The extension device can extend the height of a drapery system while advantageously allowing use of the mounting slots of the original upright drapery pipe to receive a drape support.

### BACKGROUND

Common temporary drapery systems used in decorating event spaces, such as weddings and conferences, are typically configured as a slip fit pipe and drapery system. The system typically includes at least two uprights, two bases, at least one drape support (or crossbar), and one or more drapery panels. The upright drapery pipes are vertical poles that set the height of the display. The uprights typically feature three or four slots positioned at 90° angles near the upper end of the upright drapery pipe. The horizontal drape supports may be mounted by engaging a mounting hook of a drape support with one of the slots of the upright.

Pipe and drape uprights are available in a variety of fixed or adjustable heights. Additionally, there are extension devices for increasing the height of fixed uprights by inserting the extension device into the upper end of the upright drapery pipe. However, existing extension devices obstruct the existing slots of the upright drapery pipe such that it is not possible to mount a drape support at the original height of the upright. Accordingly, there is a need for an upright extension device that allows for use of the slots of the original upright.

### BRIEF DESCRIPTION OF THE DRAWINGS

FIG. 1 shows a cross-sectional view of an exemplary extension device.

FIG. 2 shows a cross-sectional exploded view of an exemplary extension device.

### DETAILED DESCRIPTION

This disclosure relates to a double-sided extension device for upright drapery systems, such as those used in decorating temporary event spaces. The extension device can extend the height of a drapery system while advantageously allowing for use of slots of the original upright to receive a drape support.

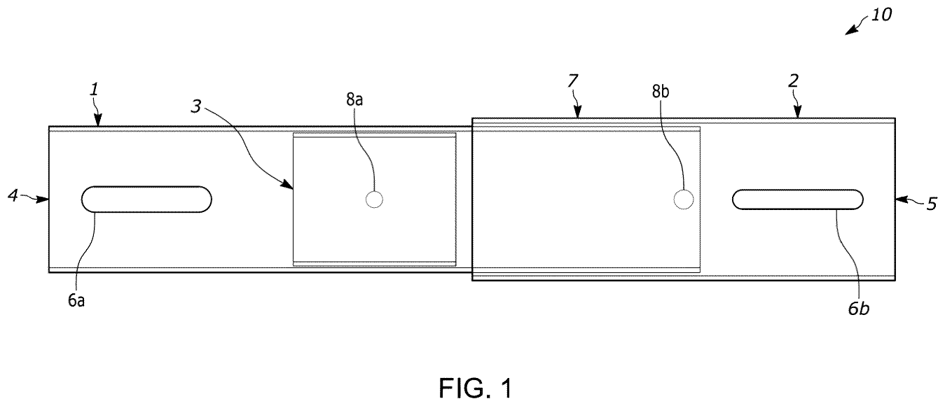

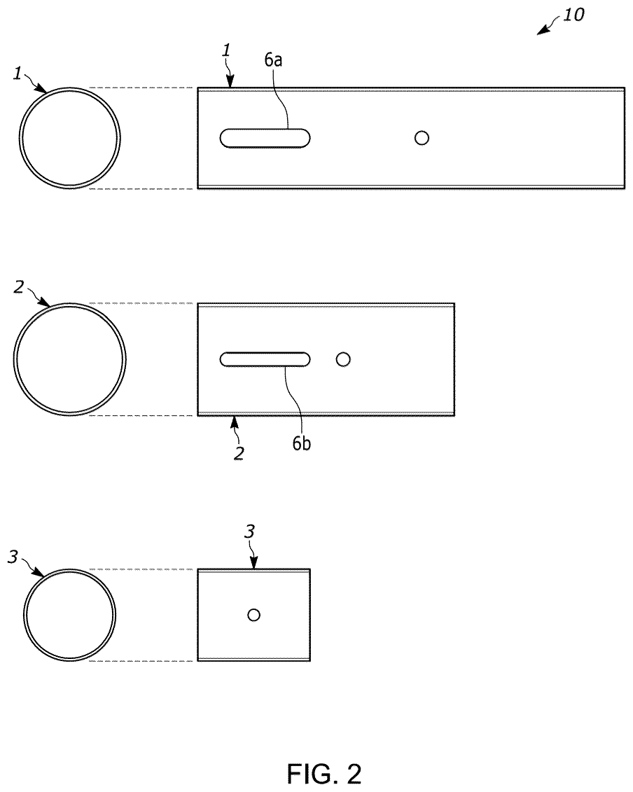

As shown in FIGS. 1 and 2, the extension device 10 for a drapery system includes a cylindrical body 7 having a first end 4 and a second end 5. Each of the first end 4 and second end 5 is configured to mount to an upright drapery pipe (not shown).

Typically, the cylindrical body 7 is has a tubular structure with a hollow lumen to reduce the weight of the device. As shown in FIG. 1, the cylindrical body 7 may be configured as an assembly of an inner tube 1, an outer tube 2 and an abutment support 3, each having a tubular configuration. A portion of the inner tube 1 is nested within a portion of the outer tube 2 such that the inner tube 1 extends from the outer tube 2. Additionally, the abutment support 3 may be nested entirely within the inner tube 1.

A slot 6 is positioned at each of the first end 4 and second end 5 of the cylindrical body 7, such that both ends of the cylindrical body 7 include at least one slot (shown as 6a and 6b in FIGS. 1 and 2). Each slot 6 is generally aligned with a longitudinal axis of the cylindrical body 7. The slots 6 are configured to overlap or coincide with at least one upright slot of an upright drapery pipe when the extension device 10 is mounted to the upright drapery pipe. As a result, a horizontal drape support (not shown) may be mounted by inserting and engaging a mounting hook of a drape support through one of the slots 6 of the extension device 10 and the overlapping or coinciding upright slot of the upright drapery pipe. Advantageously, a mounting hook of a second drape support may be inserted through and engage with one of the slots 6 on the end of the cylindrical body 7 opposite the upright drapery pipe to allow for double vertical draping.

As upright drapery pipes typically have a plurality of upright slots, a plurality slots 6 may be positioned at each of the first end 4 and second end 5 of the cylindrical body 7. Suitably, the first end 4 and second end 5 of the cylindrical body 7 may each comprise two, three, four, five or more slots 6. In such examples, each of the plurality of slots 6 on the first end 4 or the second end 5 are configured to overlap with one of a plurality of upright slots of the upright drapery pipe when the extension device 10 is mounted to the upright drapery pipe. As a result, each of the existing upright slots of the upright may remain available to be used for mounting a drape support when the extension device 10 is mounted on the upright drapery pipe.

As conventional upright drapery pipes typically include between three and four upright slots, it is contemplated that the first end 4 and second end 5 of the cylindrical body 7 may comprise between three and four slots 6. The first end 4 and second end 5 of the cylindrical body 7 may comprise the same number or a different number of slots 6. For example, if one of the first end 4 and second end 5 of the cylindrical body 7 has three slots, the other of the first and second ends may have four slots.

The first end 4 and second end 5 of the cylindrical body 7 may be configured to mount to an upright drapery pipe by selecting a size and shape based on the desired upright drapery pipe. Typically, the size and shape will be selected to allow for the first end 4 or the second end 5 to receive an upper end of the upright drapery pipe therein as in slip fit pipe assembly. A suitable diameter of the cylindrical body 7 may be between 35 and 55 mm, although a larger or smaller diameter may be used depending on the dimensions of the upright drapery pipe of the drapery system.

The length of the extension device 10 may be selected according to need. A suitable distance between the slots positioned at each of the first end and second end of the cylindrical body in between about 8 and 30 inches, preferably 8 and 20 inches, although longer or shorter lengths are possible. The individual lengths of the inner tube 1, outer tube 2 and abutment support 3 are not limited. However, as shown in FIG. 2, the length of the inner tube 1 may be approximately 200 mm, the outer tube 2 may be approximately 120 mm and the abutment support 3 may be approximately 50 mm.

Rivets 8 may be used to fix the elements of the cylindrical body 7 to one another. As shown in FIG. 1, rivet 8a may join the inner tube 1 and the abutment support 3 and rivet 8b may join the inner tube 1 and the outer tube 2.

The extension device 10 may be constructed of any suitable material. Aluminum is preferred in view of cost, strength, weight and ease of manufacture.

In use, the extension device 10 may be mounted to an upright drapery pipe of a drapery display system by positioning either the first end 4 or the second end 5 of the extension device 10 over an upper end of the upright drapery pipe such that the upright drapery pipe is received within the first end or the second end. If the first end 4 is mounted to the upright drapery pipe, the upper end of the upright drapery pipe abuts an end-side of the abutment support 3 facing the first end 4. As a result, the extension device 10 rests on the top of the upright drapery pipe and the abutment support 3 provides a weight bearing surface. Alternatively, if the second end 5 is mounted to the upright drapery pipe, the upper end of the upright drapery pipe abuts an end-side of the inner tube 1 facing the second end 5. As a result, the extension device 10 rests on the top of the upright drapery pipe and the inner tube 1 provides a weight bearing surface. In either case, the extension device can be rotated around the upright drapery pipe to align the slots 6 with the slots of the upright drapery pipe. Once the extension device 10 is mounted to the upright drapery pipe, a horizontal drape support may be mounted to the extension device 10 by inserting and engaging a mounting hook of a drape support through one of the slots 6 of the extension device 10 and the overlapping or coinciding upright slot of the upright drapery pipe. Additionally, if desired, a mounting hook of a second drape support may be inserted through and engage with one of the slots 6 on the end of the cylindrical body 7 opposite the upright drapery pipe to provide for double vertical draping.

What is claimed:

1. An extension device for a drapery system comprising:
a cylindrical body having a first end and a second end, each of the first and second ends being configured to mount to an upright drapery pipe,
a slot positioned at each of the first end and second end of the cylindrical body,
wherein at least one of the slots is configured to overlap with at least one upright slot of the upright drapery pipe when the extension device is mounted to the upright drapery pipe.

2. The extension device of claim 1, wherein a plurality of slots are positioned at the first end or second end of the cylindrical body.

3. The extension device of claim 2, wherein each of the plurality of slots is configured to overlap with one of a plurality of upright slots of the upright drapery pipe when the extension device is mounted to the upright drapery pipe.

4. The extension device of claim 1, wherein the cylindrical body is tubular.

5. The extension device of claim 1, wherein the cylindrical body is configured as an assembly of an outer tube, an inner tube and an abutment support, wherein a portion of the inner tube is nested within the outer tube and the abutment support is nested within the inner tube.

6. The extension device of claim 1, wherein one of the first and second ends of the cylindrical body comprises three slots and the other of the first and second ends of the cylindrical body comprises four slots.

7. The extension device of claim 1, wherein the first end or the second end mount to an upright drapery pipe by receiving a portion of an upper end of the upright drapery pipe within the first end or the second end.

8. The extension device of claim 1, wherein the cylindrical body is aluminum.

9. The extension device of claim 1, wherein a distance between the slots positioned at each of the first end and second end of the cylindrical body is about 8 to about 30 inches.

10. The extension device of claim 1, wherein the first end and/or the second end have three or four slots.
